(19) United States
(12) Patent Application Publication
(10) Pub. No.: US 2014/0080037 A1
(43) Pub. Date: Mar. 20, 2014

(54) ELECTRODE FOR FUEL CELL AND FUEL CELL INCLUDING THE SAME

(71) Applicant: SAMSUNG ELECTRONICS CO., LTD., Suwon-si (KR)

(72) Inventors: Suk-gi HONG, Seongnam-si (KR); Jung-ock Park, Yongin-si (KR); Ki-chun KIL, Seoul (KR); Seong-eun PARK, Seoul (KR); Un-gyu PAIK, Seoul (KR)

(73) Assignee: SAMSUNG ELECTRONICS CO., LTD., Suwon-si (KR)

(21) Appl. No.: 13/868,451

(22) Filed: Apr. 23, 2013

(30) Foreign Application Priority Data
Sep. 20, 2012 (KR) 10-2012-0104618

(51) Int. Cl. H01M 4/86

(52) U.S. Cl. CPC H01M 4/8657
USPC 429/524; 429/523; 429/527; 429/526; 429/525; 429/534; 429/530

(57) ABSTRACT

An electrode for a fuel cell including a gas diffusion layer, and a catalyst layer bound to at least one surface of the gas diffusion layer and including a catalyst and a binder; and a fuel cell including the electrode.

### CROSS-REFERENCE TO RELATED APPLICATIONS

This application claims priority to and the benefit of Korean Patent Application No. 10-2012-0104618, filed on Sep. 20, 2012, and all the benefits accruing therefrom under 35 U.S.C. §119, the content of which is incorporated herein in its entirety by reference.

### BACKGROUND

1. Field

The present disclosure relates to electrodes for a fuel cells, and fuel cells including the electrodes.

2. Description of the Related Art

According to types of an electrolyte and fuel used, fuel cells can be classified as polymer electrolyte membrane fuel cells (“PEMFCs”), direct methanol fuel cells (“DMFCs”), phosphoric acid fuel cells (“PAFCs”), molten carbonate fuel cells (“MCFCs”), and solid oxide fuel cells (“SOFCs”).

In general, PEMFCs and DMFCs include a membrane-electrode assembly (“MEA”) including an anode, a cathode, and a polymer electrolyte membrane interposed between the anode and the cathode. In the anode supplied with hydrogen or other kind of fuel, fuel oxidation occurs to generate protons, which are then migrated into the cathode through the electrolyte membrane. In the cathode supplied with oxygen or air, oxygen reduction occurs, creating a voltage difference between the anode and the cathode, and thus generating electricity.

In general, an electrode of fuel cells includes a catalyst layer including a catalyst, and a gas diffusion layer supporting the catalytic layer.

However, when an electrode of a fuel cell is manufactured by coating a catalyst layer on a gas diffusion layer, the adhesion strength of the catalyst layer to the gas diffusion layer is usually not strong enough to apply a roll-coating process and to ensure ease of electrode handling. Therefore, there remains a need for an electrode for a fuel cell with improved adhesion strength between its catalyst layer and its gas diffusion layer.

### SUMMARY

Provided are an electrode catalyst layer for a fuel cell, an electrode for a fuel cell with improved adhesion strength between a catalyst layer and a gas diffusion layer of the electrode, a fuel cell including the electrode including the electrode catalyst layer.

Additional aspects will be set forth in part in the description which follows and, in part, will be apparent from the description, or may be learned by practice of the presented embodiments.

According to an aspect, an electrode for a fuel cell includes: a gas diffusion layer; and a catalyst layer bound to at least one surface of the gas diffusion layer and including a catalyst and a binder.

At least one of the catalyst and the binder may have an acidic functional group or a basic functional group.

According to another aspect, an electrode catalyst layer for a fuel cell includes: a catalyst having an acidic functional group or a basic functional group; and a binder having a basic functional group or an acidic functional group which is effective to form a chemical bond with the acidic functional group or the basic functional group of the catalyst.

According to another aspect, an electrode for a fuel cell includes: a gas diffusion layer; and an electrode catalyst layer disposed on the gas diffusion layer, wherein the electrode catalyst layer includes a catalyst having an acidic functional group or a basic functional group, and a binder having a basic functional group or an acidic functional group which is effective to form a chemical bond with the acidic functional group or the basic functional group of the catalyst.

According to another aspect, a fuel cell includes the above-defined electrode.

### BRIEF DESCRIPTION OF THE DRAWINGS

These and/or other aspects will become apparent and more readily appreciated from the following description of the embodiments, taken in conjunction with the accompanying drawings of which:

FIGS. 1 to 3 are diagrams schematically illustrating electrodes for fuel cells, according to embodiments;

FIG. 4 is a perspective exploded view of a fuel cell according to an embodiment;

FIG. 5 is a cross-sectional diagram of a membrane-electrode assembly (“MEA”) that forms the fuel cell of FIG. 4;

FIG. 6 is a graph illustrating the binding strength of catalyst layers in electrodes of Examples 1 to 4, and Comparative Example 1;

FIGS. 7 to 10 are scanning electron microscopy (“SEM”) images of the electrodes of Examples 2 to 4, and Comparative Example 1, respectively; and

FIG. 11 is a graph of voltage (volts, V) versus to current density (ampere per square centimeter, A/cm²) in fuel cells of Manufacture Example 1 and Comparative Manufacture Example 1.

### DETAILED DESCRIPTION

Reference will now be made in detail to embodiments of electrodes for fuel cells, and fuel cells including the electrodes, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer, or section. Thus, a first element, component, region, layer, or section discussed below could be termed a second element, component, region, layer, or section without departing from the teachings of the present embodiments.

The terminology used herein is for the purpose of describing particular embodiments only and is not intended to be limiting. As used herein, the singular forms “a,” “an” and “the” are intended to include the plural forms as well, unless the context clearly indicates otherwise. Unless specified otherwise, the term “or” means “and/or.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

“Alkyl” as used herein refers to a monovalent group derived from a straight or branched chain saturated aliphatic hydrocarbon, and having a specified number of carbon atoms. Alkyl groups include, for example, groups having from 1 to 50 carbon atoms (C1-C50 alkyl).

“Aryl” as used herein refers to a monovalent group derived from a cyclic moiety in which all ring members are carbon and at least one ring is aromatic, and having a specified number of carbon atoms. Aryl groups include, for example, groups having from 6 to 50 carbon atoms (C6-C50 aryl).

“Amino” as used herein refers to a monovalent group of the general formula NRR, wherein each R is independently hydrogen, a C1-C50 alkyl group, or a C6-C50 aryl group.

According to an exemplary embodiment of the present disclosure, there is provided an electrode for a fuel cell, the electrode including: a gas diffusion layer; and a catalyst layer bound to at least one surface of the gas diffusion layer and including a catalyst and a binder.

The term “bound” as used herein refers to a gas diffusion layer and a catalyst layer being chemically and/or physically bonded together, or adhered to one another. The bonds may be ionic bonds.

According to embodiments of the present disclosure, the catalyst layer may be strongly bound to the gas diffusion layer with improved adhesion strength.

The adhesion strength may be from about 75% to about 100%, for example, from about 90% to about 100%. The adhesion strength may be measured as a change in weight of an electrode including the gas diffusion layer and the catalyst layer, before and after a blowing test using an air gun.

In some embodiments, the binder in the catalyst layer may have an acidic functional group or a basic functional group (but not both). This binder may be used along with a binder known for use in forming the catalyst layer.

A chemical bond between the gas diffusion layer and the catalyst layer may be a covalent bond, such as an amide bond, resulting from a reaction between an amino group and a carboxylic acid group, or an ionic bond formed between the acidic functional group and the basic functional group.

The gas diffusion layer may have an acidic functional group or a basic functional group (but not both). The acidic functional group or basic functional group of the gas diffusion layer may form a chemical bond with the basic functional group or acidic functional group of at least one of the catalyst and binder to bind with the catalyst layer with string adhesion strength.

According to another exemplary embodiment, there is provided an electrode catalyst layer for fuel cells, the electrode catalyst layer including a catalyst having an acidic functional group or a basic functional group (but not both), and a binder including a basic functional group or an acidic functional group (but not both) which are effective to form a chemical bond with the acidic functional group or the basic functional group of the catalyst.

In some embodiments, when a catalyst having, for example, a basic functional group (for example, an amino group) and a binder having an acidic functional group (for example, a carboxylic acid group) are used to form the catalyst layer, the basic functional group of the catalyst and the acidic functional group of the binder may form a covalent bond such as an amide bond, leading to an improvement in binding strength between the components of the catalyst layer, and the adhesion strength of the catalyst layer to the gas diffusion layer.

The binder having an acidic functional group may be at least one selected from a poly(olefin) including at least one selected from a carboxylic acid group, a sulfonic acid group, or a phosphoric acid group, a halogenated poly(olefin) including at least one selected from a carboxylic acid group, a sulfonic acid group, or a phosphoric acid group, a poly(acrylic) acid, a poly(methacrylic) acid, an isobutylene-maleic acid copolymer, a butadiene-maleic acid copolymer, and a butadiene-maleic acid-olefin terpolymer. For example, the polymer may be the poly(olefin) including a carboxylic acid group, a sulfonic acid group, or a phosphoric acid group.

The catalyst layer may further include a carbonaceous material.

The carbonaceous material may be at least one selected from carbon powder, carbon black, acetylene black, ketjen black, activated carbon, carbon nanotubes, carbon nanofibers, carbon nanowires, carbon nanohorns, carbon aerogel, carbon cryogel, and carbon nanorings.

When such a carbonaceous material is added to form the catalyst layer, the adhesion strength of the components of the catalyst layer may be improved.

The carbonaceous material is not specifically limited. The carbonaceous material may be prepared using a known method, or may be any commercially available carbonaceous material. In an embodiment, the carbonaceous material may be a material having an acidic group exposed on a surface thereof. For example, carbon nanotubes with a carboxylic acid group exposed on a surface or at a terminal thereof may be used as the carbonaceous material. Carbon nanotubes with a carboxylic acid group on a surface or terminal thereof may form a chemical bond (for example, a covalent bond such as an amide bond) with the basic functional group (for example, an amino group) of the catalyst or the binder of the catalyst layer.

The carbon nanotubes with a carboxylic acid group (—COON) on a surface or at a terminal thereof may be a commercially available product. In some embodiments, general carbon nanotubes may be further treated prior to use. For example, the carbon nanotubes may be prepared by thermally treating carbon nanotubes at a high temperature of about 370° C. for about 1 hour, adding hydrochloric acid to the thermally treated carbon nanotubes to form a mixture, sonicating the mixture for about 3 hours, stirring the mixture in a mixed solution of sulfuric acid and hydrogen peroxide (2:1 to 5:1 by volume) for about 20 hours to about 30 hours, for example, for about 25 hours to about 30 hours, diluting the mixture with distilled water to obtain a carbon nanotube suspension, filtering the carbon nanotube suspension through a filter having a pore diameter of about 0.1 micrometers (“μm”) to about 0.5 μm, for example, about 0.3 μm to about 0.5 μm, and drying the filtered product to form a carbon nanotube with the carboxylic acid group (—COON) on a surface or at a terminal thereof.

The acidic functional group may be at least one selected from a carboxylic acid group, a phosphoric acid group, a sulfonic acid group, and a hydroxy group. The basic functional group may be at least one selected from an amino group, a pyridine group, a pyridazine group, a pyrimidine group, a pirazine group, a 1,2,3-triazine group, a 1,2,4-triazine group, a 1,3,5-triazine group, an oxazole group, a thiazole group, a 1H-1,2,3-triazole group, a 1H-1,2,4-triazole group, 2H-1,2,3-triazole group, a 1 H-tetrazole group, a 2H-tetrazole group, and an imidazole group.

For example, the catalyst layer may alternatively include a catalyst having a basic functional group, and a binder including an acidic functional group; a catalyst layer may include a catalyst having an acidic functional group, and a binder having a basic functional group; a catalyst layer may include a catalyst, and a binder each having an acidic functional group; or a catalyst layer may include a catalyst having a basic functional group, a binder having an acidic functional group, and a carbonaceous material.

In some embodiments of the electrode, the gas diffusion layer may have a basic functional group, while the catalyst layer may alternatively include; i) a catalyst having a basic functional group and a binder having an acidic functional group; ii) a catalyst and a binder each having an acidic functional group; or iii) a catalyst having a basic functional group, a binder having an acidic functional group, and a carbonaceous material.

The catalyst having a basic functional group may be a catalyst bound to an amino (—NH₂) group.

The catalyst may further include at least one catalyst metal selected from platinum (Pt), iron (Fe), cobalt (Co), nickel (Ni), ruthenium (Ru), rhodium (Rh), palladium (Pd), osmium (Os), iridium (Ir), copper (Cu), silver (Ag), gold (Au), tin (Sn), titanium (Ti), chromium (Cr), and an alloy of at least two thereof; or may be a supported catalyst including at least one catalyst metal selected from platinum (Pt), iron (Fe), cobalt (Co), nickel (Ni), ruthenium (Ru), rhodium (Rh), palladium (Pd), osmium (Os), iridium (Ir), copper (Cu), silver (Ag), gold (Au), tin (Sn), titanium (Ti), chromium (Cr), and an alloy of at least two thereof that is disposed on a carbonaceous support.

An example of the support catalyst may be a Pt/C catalyst with platinum disposed on a carbonaceous support. An amount of platinum in the support catalyst may be from about 10 parts to 90 parts by weight, for example, from about 10 to about 70 parts by weight, based on a total of 100 parts by weight of the supported catalyst.

The catalyst layer may include a binder having an acidic functional group. A wide variety of binders can be used, and are generally polymeric materials provided with an effective amount of acidic functionality by copolymerization or grafting. The binders are further selected to withstand the operating conditions of the electrode, and in particular to withstand the operating conditions of fuel cells. The binder having an acidic functional group may be at least one selected from a poly(olefin) including at least one selected from a carboxylic acid group, a sulfonic acid group, and a phosphoric acid group, a halogenated poly(olefin) including at least one selected from a carboxylic acid group, a sulfonic acid group, and a phosphoric acid group, a poly(acrylic acid), a poly(methacrylic acid), an isobutylene-maleic acid copolymer, a butadiene-maleic acid copolymer, for example a polybutadiene grafted or otherwise functionalized with maleic anhydride, and a butadiene-maleic acid-olefin terpolymer, for example a polybutadiene grafted with maleic acid-styrene copolymer.

The preceding polymers are all inclusive of the corresponding copolymers. For example, the poly(olefin) or halogenated poly(olefin) can be at least one selected from poly(ethylene), poly(propylene, poly(vinylchloride), ethylene-propylene copolymer), ethylene-propylene-diene terpolymer, ethylene vinyl acetate copolymer, ethylene butylacrylate copolymer, poly(vinylidenedichloride), poly(vinylfluoride), poly(vinylidenedifluoride), vinylidene fluoride-tetrafluoroethylene copolymer, vinylidene-hexafluoropropylene copolymer, chlorotrifluorethylene-ethylene copolymer, chlorotrifluoroethylene-propylene copolymer, poly(chloroethylene), ethylene-tetrafluoroethylene copolymer, propylene-tetrafluoroethylene copolymer, propylene-hexafluoropropylene copolymer, and ethylene-hexafluoropropylene copolymer. Methods for the manufacture of such polymers are known. Poly(olefins) and halogenated poly(olefins), for example, can be provided with acid groups by grafting the polymers with side chains including the acidic groups.

In an embodiment, the binder having an acidic functional group may be at least one selected from a poly(olefin) including at least one selected from a carboxylic acid group, a sulfonic acid group, or a phosphoric acid group, a halogenated poly(olefin) including at least one selected from a carboxylic acid group, a sulfonic acid group, and a phosphoric acid group, a poly(acrylic) acid, a poly(methacrylic) acid, an isobutylene-maleic acid copolymer, a butadiene-maleic acid copolymer, and a butadiene-maleic acid-olefin terpolymer.

An amount of the binder in the catalyst layer may be from about 1 part to about 20 parts by weight, for example, from about 5 parts to about 20 parts by weight, based on a total of 100 parts by weight of the catalyst. When the amount of the binder is within this range, the catalyst layer may have improved adhesion strength to the gas diffusion layer.

When the binder having an acidic functional group or a basic functional group (but not both) is used together with a binder known for use in forming electrode catalyst layers, an amount of the common binder may be from 1 part to about 95 parts by weight, for example, from 10 parts to about 95 parts by weight, based on 100 parts by weight of a total weight of the two binders.

In some other embodiments, the catalyst layer may include a binder having a basic functional group, and a catalyst having an acidic functional group. In this regard, the gas diffusion layer may be untreated to lack a basic or acidic functional group.

The binder having a basic functional group may be, for example, a resin polymer with one functional group selected from an amino group, a pyridine group, a pyridazine group, a pyrimidine group, a pirazine group, a 1,2,3-triazine group, a 1,2,4-triazine group, a 1,3,5-triazine group, an oxazole group, a thiazole group, a 1H-1,2,3-triazole group, a 1H-1,2,4-triazole group, 2H-1,2,3-triazole group, a 1H-tetrazole group, a 2H-tetrazole group, and an imidazole group. The polymer resin with an amino group may be any polymer with an amino group (—NH₂). In some embodiments, the resin with an amino group may be a polymer resin with an amino group (—NH₂), such as polyimide resin or polyamide resin. The polyimide resin having the amino group may be prepared using any known method, for example, a method involving polymerizing diamine and dianhydride in a solvent to prepare polyamic acid, and imidizing the polyamic acid under a variety of imidization conditions, for example, at an elevated temperature to retain the amino group (—NH₂). That is, the imidization may include heating at a temperature of from about 80° C. to about 400° C., for example, from about 150° C. to about 400° C. for about 1 hour to about 17 hours, for example, for about 3 hours to about 17 hours. The dianhydride used in preparing polyimide resin with an amino group is not particularly limited. The dianhydride may be at least one selected from 2,2-bis(3,4-dicarboxyphenyl)hexafluoropropane dianhydride (“FDA”), 4-(2,5-dioxotetrahydrofuran-3-yl)-1,2,3,4-tetrahydronaphthalene-1,2-dicarboxylic anhydride (“TDA”), 4,4′-(4,4′-isopropylidenediphenoxy)bis(phthalic anhydride) (“HBDA”), 3,3′-(4,4′-oxydiphthalic dianhydride) (“ODPA”), and 3,4,3′,4′-biphenyltetracarboxylic dianhydride (“BPDA”).

The diamine used in preparing polyimide resin with an amino group is also not particularly limited. That is, the diamine may be at least one selected from 2,2-bis[4-(4-aminophenoxy)-phenyl]propane (“6HMDA”), 2,2′-bis(trifluoromethyl)-4,4′-diaminobiphenyl (“2,2′-TFDB”), 3,3′-bis(trifluoromethyl)-4,4′-diaminobiphenyl (“3,3′-TFDB”), 4,4′-bis(3-aminophenoxy)diphenylsulfone (“DBSDA”), bis(3-aminophenyl)sulfone (“3DDS”), bis(4-aminophenyl)sulfone (“4DDS”), 1,3-bis(3-aminophenoxy)benzene (“APB-133”), 1,4-bis(4-aminophenoxy)benzene (“APB-134”), 2,2′-bis[3(3-aminophenoxy)phenyl]hexafluoropropane (“3-BDAF”), 2,2′-bis[4(4-aminophenoxy)phenyl]hexafluoropropane (“4-BDAF”), and oxydianiline (“ODA”).

A dianhydride component and a diamine component as listed above may be dissolved in an organic solvent in equal molar quantities, and reacted together to prepare a polyamic acid solution.

Subsequently, polyimide is prepared from the polyamic acid solution using a known method. For example, a polyimide film may be obtained by casting the polyamic acid solution onto a support and imidizing the resultant material. The imidization method may be thermal imidization, chemical imidization, or a combination thereof.

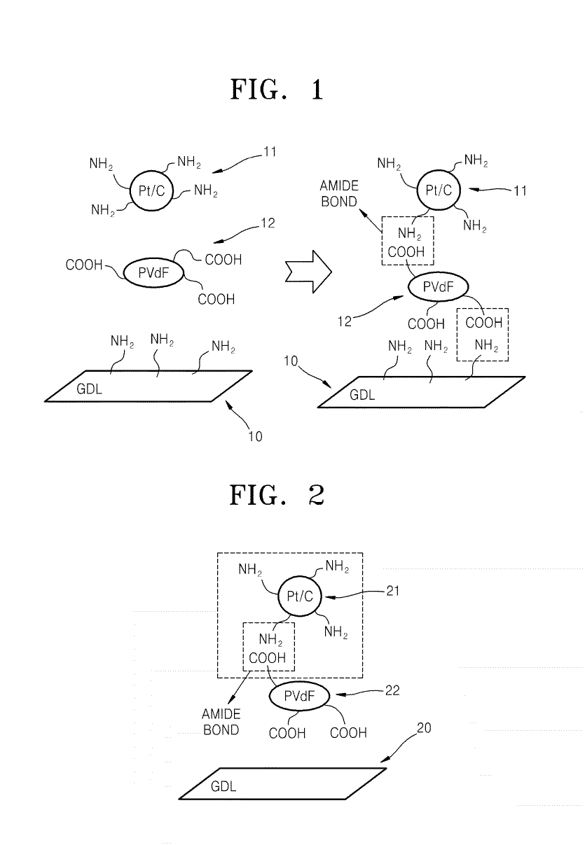

An electrode for a fuel cell according to an embodiment will be described with reference to FIGS. 1 to 3.

Referring to FIG. 1, a gas diffusion layer (“GDL”) 10 includes an amino group (—NH₂), and a catalyst layer including a supported catalyst 11 including an amino group, and a polyvinylidenefluoride (“PVDF”) 12 including —COOH as a binder are on the GDL 10.

As the supported catalyst, a support catalyst (Pt/C) with platinum disposed on a carbonaceous support may be used.

The —COON group of the polyvinylidenefluoride 12 may form amide bonds with the amino group of the GDL 10 and with the amino group of the supported catalyst (Pt/C) 11, so that the catalyst layer may be bound strongly to the GDL 10.

FIG. 2 is a schematic view of an electrode for a fuel cell, according to another embodiment.

Referring to FIG. 2, a catalyst layer disposed on a GDL 20 includes a supported catalyst Pt/C 21 including an amino group, and polyvinylidenefluoride 22 including —COON as a binder. The GDL 20 is untreated so that the GDL 20 does not include an alkali or acidic functional group.

The amino group introduced into the support catalyst (Pt/C) 21 may form an amide bond with the carboxylic acid group (—COON) introduced into the polyvinylidenefluoride 22.

FIG. 3 is a schematic view of an electrode for a fuel cell, according to another embodiment.

Referring to FIG. 3, the electrode includes a supported catalyst (Pt/C) 31, and polyvinylidenefluoride 32 including a carboxylic acid (—COON) group as a binder on a GDL 30 including an amino group. The amino group of the GDL 30 may form an amino group with the carboxylic acid group of the polyvinylidenefluoride 32. The supported catalyst (Pt/C) 31 does not include an acidic functional group or a basic functional group.

In the electrode of FIG. 2 for a fuel cell, the amino group of the catalyst forms an amide group with the carboxylic acid group of the binder, as in the electrode of FIG. 1. Alternatively, in the electrode of FIG. 3 for a fuel cell, the amino group of the GDL 30 may form an amide bond with the carboxylic acid group of the binder. As a result, in either embodiment of FIG. 1, 2, or 3, the adhesion strength to the GDL may be improved.

Hereinafter, a method of manufacturing, for example, the electrode of FIG. 1 for a fuel cell, according to an embodiment will be described in more detail.

First, a GDL including a basic functional group, such as an amino group, is prepared according to the following method.

The GDL may be treated with UV/oxygen (O₂) to include a hydroxy group. The GDL including the hydroxy group may be used as a GDL including an acid functional group.

A mixture of a solvent and an amino silane compound is stirred at a temperature of about 25° C. to about 50° C., for example, about 30° C. to about 40° C. Afterward, the GDL including the hydroxyl group is immersed in the mixture for a predetermined period of time.

Examples of the solvent may be toluene and ethanol. Examples of the amino silane compound may be 3-aminopropyltriethoxysilane and 3-aminopropyltrimethoxysilane.

An amount of the solvent may be from about 1,000 parts to about 10,000 parts by volume, for example, about 3,000 parts to about 8,000 parts by volume, based on a total of 100 parts by weight of the amino silane compound.

An amount of the amino silane compound may be adjusted to render the final GDL including the amino group hydrophilicity.

The GDL obtained through the processes is washed with a solvent and deionized water, and then baked at a temperature of from about 100 to about 120° C.

The resulting GDL including the amino group may be subjected to ultrasonication, if desired. Advantageously, the ultrasonication may physically remove materials adsorbed onto the GDL. The GDL including the amino group is obtained as a result of a reaction between the hydroxyl group on the surface of the GDL and 3-aminopropyltriethoxysilane. For example, the GDL may be obtained through dehydration condensation reaction between a hydrolysis product of the 3-aminopropyltriethoxysilane and the hydroxyl group on the surface of the GDL, or through dehydration polycondensation reaction between a hydrolysis product of the 3-aminopropyltriethoxysilane and the hydroxyl group on the surface of the GDL.

The catalyst including a basic functional group, such as an amino group, may be obtained.

First, a catalyst is added to an acid, and the resulting mixture is reacted under reflux and stirring to obtain a catalyst including a carboxylic acid group. An example of the acid is a mixture of sulfuric acid and nitric acid. A mixing ratio of the sulfuric acid and the nitric acid may be from about 1:1 to about 3:1 by volume, for example, about 2:1 to about 3:1 by volume.

The catalyst including the carboxylic acid group, obtained through the above processes, may be used as the catalyst including an acidic functional group.

The catalyst including the carboxylic acid group may be mixed and reacted with an amine compound to obtain a catalyst including an amino group.

The amine compound may be any compound with a primary amino group. Examples of the amine compound are ethylenediamine and ethyldiethanolamine.

An amount of the amine compound may be from about 500 parts to about 1,000 parts by weight, for example, about 750 parts to about 1,000 parts by weight, based on a total of 100 parts by weight of the catalyst including the carboxylic acid group. When the amount of the amine compound is within this range, the catalyst and the binder may be chemically bound to a satisfactory level, and the catalyst layer may have improved adhesion strength to the GDL.

The reaction temperature may be from about 40° C. to about 65° C., for example, from about 50° C. to about 65° C. When the reaction temperature is within this range, the reaction may take place.

Subsequently, the catalyst including an amino group, a binder, and a solvent are mixed together to form a catalyst layer composition.

The catalyst layer composition may further include a carbonaceous material.

An amount of the carbonaceous material may be from about 1 part to about 50 parts by weight, for example, from about 10 parts to about 50 parts by weight, based on a total of 100 parts by weight of the catalyst. When the amount of the carbonaceous material is within this range, the catalyst layer of the electrode may have improved adhesion strength.

The catalyst may include a catalyst metal, and a carbonaceous support carrying the catalyst metal.

The carbonaceous support may include at least one selected from carbon powder, carbon black, acetylene black, ketjen black, activated carbon, carbon nanotubes, carbon nanofibers, carbon nanowires, carbon nanohorns, carbon aerogel, carbon cryogel, and carbon nanorings.

The catalyst metal may include at least one selected from platinum (Pt), iron (Fe), cobalt (Co), nickel (Ni), ruthenium (Ru), rhodium (Rh), palladium (Pd), osmium (Os), iridium (Ir), copper (Cu), silver (Ag), gold (Au), tin (Sn), titanium (Ti), chromium (Cr), and an alloy thereof.

An amount of the catalyst metal may be from about 10 parts to about 90 parts, for example, from about 30 parts to 70 parts, based on 100 parts by weight based on a total weight of the support and the catalyst metal. When the amount of the catalyst metal is within this range, a utilization rate of the crystal metal may be high, and a fuel cell using the catalyst metal may retain high cell performance.

The binder may be at least one selected from polyvinylidenefluoride (“PVdF”), polytetrafluoroethylene (“PTFE”), a vinylidenefluoride-hexafluoropropylene copolymer, and a fluorine-terminated phenoxide-based hyperbranched polymer (“HPEF”).

The binder may be a binder including an acidic functional group or a basic functional group (but not both).

The binder including the acidic functional group may be at least one selected from a poly(olefin), for example a poly(vinylidenefluoride) including at least one selected from a carboxylic acid group, a sulfonic acid group, or a phosphoric acid group, a halogenated poly(olefin), for example a fluorovinylidene polymer including at least one selected from a carboxylic acid group, a sulfonic acid group, or a phosphoric acid group, poly(acrylic) acid, poly(methacrylic) acid, an isobutylene-maleic acid copolymer, a butadiene-maleic acid copolymer, and a butadiene-maleic acid-olefin terpolymer.

The fluorovinylidene polymer with a carboxylic acid group may be obtained by copolymerizing a first monomer for forming the fluorovinylidene polymer, and a second monomer selected from an unsaturated monobasic acid, an unsaturated dibasic acid, and alkylesters thereof.

An amount of the second monomer may be from about 0.1 part to about 3 parts by weight, for example, from about 1 part to about 3 parts by weight, based on 100 parts by weight of the first monomer.

An example of the unsaturated monobasic acid is acrylic acid, and an example of the unsaturated dibasic acid is maleic acid.

As the fluorovinylidene polymer with a carboxylic acid group, a commercially available material, for example, a polymer (KF9300, available from Kureha) may be used.

The binder including a basic functional group may be a resin including an amino group as described above.

The solvent may be at least one selected from deionized water, N-methylpyrrolidone (“NMP”), N,N-dimethylacetamide (“N,N-DMAc”), dimethylformamide (“N,N-DMF”), trifluoroacetic acid (“TFA”), methanol, ethanol, cyclohexanone, and chlorobenzene. An amount of the solvent may be from about 100 to about 2,000 parts by weight, for example, from about 500 to about 2,000 parts by weight, based on 100 parts by weight of the catalyst. When the amount of the solvent is within this range, the formation of the catalyst layer is facilitated.

The catalyst layer composition may further include a proton conductor, such as phosphoric acid, or an aqueous phosphoric acid solution.

An electrode catalyst layer may be formed by coating or printing the catalyst layer composition on the GDL, and drying the coated catalyst layer composition.

In manufacturing the electrode for a fuel cell, the drying is not particularly limited. The drying may be performed by a common drying process at a temperature of about 60° C. to 150° C., for example, about 80° C. to about 120° C., or a freeze-drying process performed at a temperature of about −20° C. to about −60° C., for example, about −40° C. to about −60° C.

The method of manufacturing the electrode for a fuel cell may further include treating with an acidic solution, for example, a phosphoric acid solution, after the drying.

In the electrode for a fuel cell manufactured through the above processes, the adhesion strength between the catalyst layer and the gas diffusion layer may be improved. Accordingly, the electrode may be manufactured using a roll-coating process and may be stored in roll-form.

According to another exemplary embodiment, there is provided a fuel cell including a cathode, an anode, and an electrolyte membrane disposed between the cathode and the anode, at least one of the cathode and the anode being the above-described electrode.

The fuel cell may be a phosphoric acid fuel cell (“PAFC”), a polymer electrolyte fuel cell (“PEMFC”), or a direct methanol fuel cell (“DMFC”).

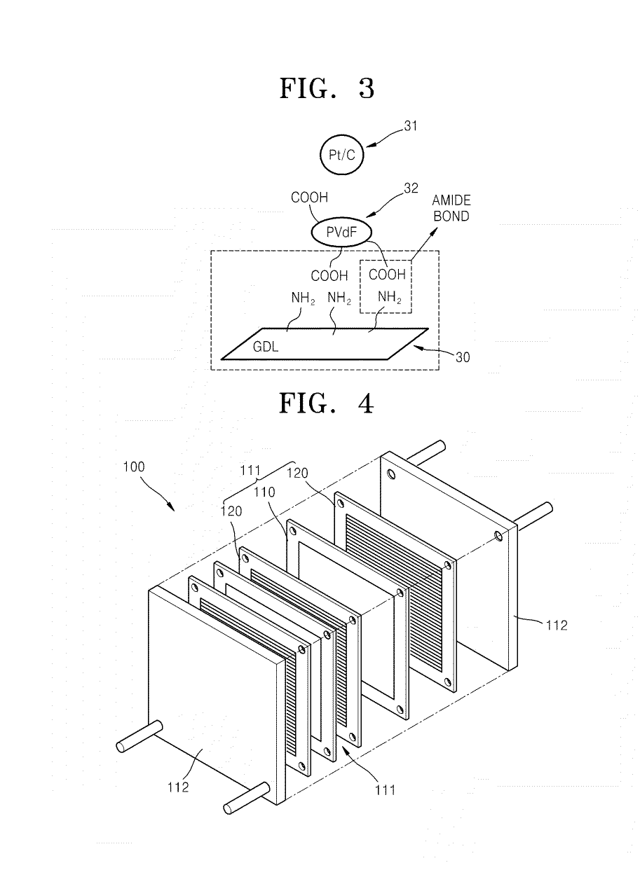

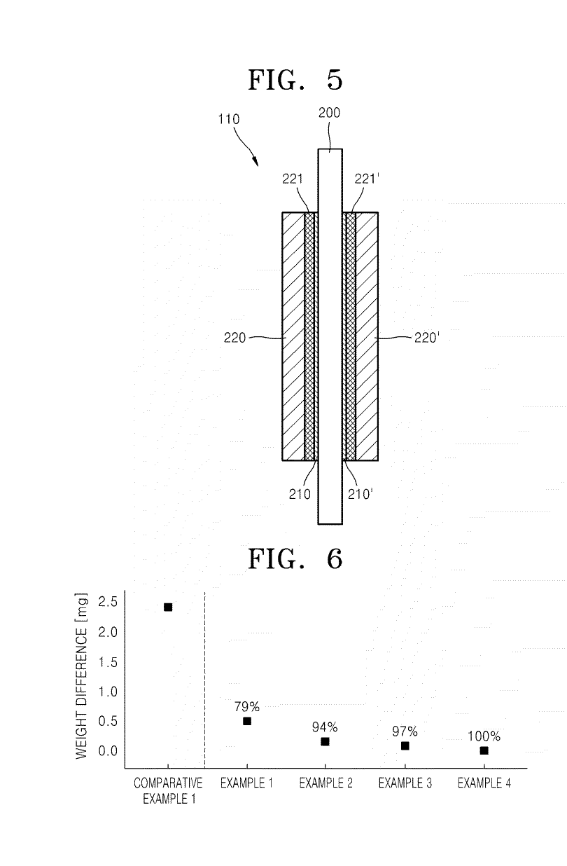

FIG. 4 is a perspective exploded view of a fuel cell 100 according to an embodiment, and FIG. 5 is a cross-sectional diagram of a membrane-electrode assembly (“MEA”) that forms the fuel cell 100 of FIG. 4.

Referring to FIG. 4, the fuel cell 100 includes two unit cells 111 which are supported by a pair of holders 112. Each unit cell 111 includes an MEA 110, and bipolar plates 120 respectively disposed on lateral sides of the MEA 110 in a thickness direction of the MEA 110. Each bipolar plate 20 includes a conductive metal, carbon or the like, and serves as a current collector by being bound to the MEA 110, and also supplies oxygen and fuel to catalyst layers of the MEA 110.

Although the fuel cell 100 of FIG. 4 includes two unit cells 111, the number of the unit cells 111 is not limited to only two, and may be up to several tens to hundreds according to the characteristics required for the fuel cell 1.

Referring to FIG. 5, each MEA 110 includes an electrolyte membrane 200; catalyst layers 210 and 210′ respectively disposed on either side of the electrolyte membrane 100 in the thickness direction thereof, one of the catalyst layers 210 and 210′ including the electrode catalyst according to an embodiment; first gas diffusion layers 221 and 221′ respectively stacked on the catalyst layers 210 and 210′; and second gas diffusion layers 220 and 220′ respectively stacked on the first gas diffusion layers 221 and 221′.

The catalyst layers 210 and 210′ function as a fuel electrode and an oxygen electrode, each including a catalyst and a binder therein. The catalyst layers 210 and 210′ may further include a material that may increase the electrochemical surface area of the catalyst.

The first gas diffusion layers 221 and 221′ and the second gas diffusion layers 220 and 220′ may each be formed of a material such as, for example, carbon sheet or carbon paper. The first gas diffusion layers 221 and 221′ and the second gas diffusion layers 220 and 220′ diffuse oxygen and fuel supplied through the bipolar plates 120 into the entire surfaces of the catalyst layers 210 and 210′.

The fuel cell 100 including the MEA 110 operates at a temperature of 40 to 300° C., for example, 100 to 300° C. Fuel such as hydrogen is supplied through one of the bipolar plates 120 into a first catalyst layer, and an oxidant such as oxygen is supplied through the other bipolar plate 120 into a second catalyst layer. Then, hydrogen is oxidized into protons (H⁺) in the first catalyst layer, and the protons are migrating to the second catalyst layer through the electrolyte membrane 200. Then, the protons electrochemically react with oxygen in the second catalyst layer to produce water (H₂O) and generate electrical energy. Hydrogen produced from reformation of hydrocarbons or alcohols may be used as the fuel. Oxygen as the oxidant may be supplied in the form of air.

One or more embodiments will now be described in more detail with reference to the following examples. However, these examples are for illustrative purposes only and are not intended to limit the scope of the one or more embodiments.

### PREPARATION EXAMPLE 1

### Preparation of Catalyst (Pt/C-NH₂) Including Amino Group

A support catalyst (Pt/C)(10 percent by weight (“wt %”) of Pt) was added to a mixture of H₂SO₄/HNO₃ (3:1, v/v) and then refluxed for about 24 hours while stirring to obtain a support catalyst including a carboxylic acid group (Pt/C-COOH). 1 g of this catalyst (Pt/C-COOH) was added to 10 g of ethylene diamine 10, and then stirred at about 60° C. for about 5 hours to obtain a supported catalyst including an amino group (Pt/C-C(═O)NHCH₂CH₂NH₂)(hereinafter, “Pt/C-NH₂”).

### PREPARATION EXAMPLE 2

### Preparation of Gas Diffusion Layer Including Amino Group

Carbon paper as a gas diffusion layer was treated with UV/oxygen (O₂) to obtain a gas diffusion layer including a hydroxy group (GDL-OH).

After a mixture of toluene and 3-aminopropyltriethoxysilane (100:1 by volume) was stirred at about 40° C. for about 30 minutes, the gas diffusion layer including the hydroxyl group was immersed in the mixture for about 30 minutes.

Subsequently, the gas diffusion layer was taken out of the mixture, washed with toluene, deionized water, and baked at a temperature of about 120° C. for about 20 minutes.

The baked product was subjected to ultrasonication for about 10 minutes to obtain the gas diffusion layer including an amino group.

### EXAMPLE 1

### Manufacture of Electrode for Fuel Cell

1.0 g of the catalyst of Manufacture Example 1 including with the amino group (Pt/C-NH₂, 50 wt % of Pt in Pt/C), 0.02 g of a polyvinylidenefluoride including a carboxylic acid group (the content of carboxylic acid group: about 3 wt %), and 5.0 g of N-methylpyrrolidone (“NMP”) were mixed together and stirred at room temperature (25° C.) for about 30 minutes to obtain a catalyst layer composition.

The catalyst layer composition was coated on an untreated carbon paper using a wire bar. The resulting product was dried at about 80° C. for about 1 hour, at about 120° C. for about 30 minutes, and at about 150° C. for about 10 minutes to manufacture an electrode.

### EXAMPLE 2

### Manufacture of Electrode for Fuel Cell

An electrode was manufactured in the same manner as in Example 1, except that a catalyst (Pt/C, about 50 wt % of Pt in Pt/C), instead of the catalyst of Manufacture Example 1 including the amino group (Pt/C-NH₂), was used.

### EXAMPLE 3

### Manufacture of Electrode for Fuel Cell

An electrode was manufactured in the same manner as in Example 1, except that the gas diffusion layer of Manufacture Example 2 including the amino group, instead of the untreated carbon paper as gas diffusion layer, was used.

### EXAMPLE 4

### Manufacture of Electrode for Fuel Cell

An electrode was manufactured in the same manner as in Example 1, except that the gas diffusion layer of Manufacture Example 2 including the amino group, instead of the untreated carbon paper as gas diffusion layer, was used, and 0.1 g of carbon nanotubes was further used in preparing the catalyst layer composition.

### COMPARATIVE EXAMPLE 1

### Manufacture of Electrode for Fuel Cell

1.0 g of the supported catalyst (Pt/C, about 50 wt % of Pt in Pt/C), 0.02 g of polyvinylidenefluoride, and 5.0 g of N-methylpyrrolidone (“NMP”) were mixed together and stirred at room temperature for about 30 minutes to obtain a catalyst layer composition.

The catalyst layer composition was coated on an untreated carbon paper using a wire bar. The resulting product was dried at about 80° C. for about 1 hour, at about 120° C. for about 30 minutes, and at about 150° C. for about 10 minutes to manufacture an electrode.

### MANUFACTURE EXAMPLE 1

### Manufacture of Fuel Cell

The electrode manufactured in Example 1 was cut to a size of about 3.2 cm×3.2 cm for use as a cathode.

An electrode was manufactured in the same manner as in Example 1, except that, 1.0 g of PtRu/C (about 50 wt % of PtRu in PtRu/C), 0.02 g of polyvinylidenefluoride, and 8.0 g of N-methylpyrrolidone (“NMP”) 8.0 g were used to prepare a catalyst layer composition. The electrode was cut to a size of about 3.2 cm×3.2 cm for use as an anode.

Polybenzimidazole membrane impregnated with 85 wt % of an aqueous phosphoric acid solution was used as the electrolyte membrane.

The cathode, the anode, and the electrolyte membrane were assembled into a fuel cell with an polybenzimidazole membrane disposed between the cathode and the anode.

### COMPARATIVE MANUFACTURE EXAMPLE 1

### Manufacture of Fuel Cell

A fuel cell was manufactured in the same manner as in Manufacture Example 1, except that the electrode of Comparative Example 1, instead of the electrode of Example 1, was used.

### EVALUATION EXAMPLE 1

### Adhesion Strength Test

Air was brown against the catalyst layers of the electrodes of Examples 1 to 4 and Comparative Example 1 using an air gun to test adhesion strengths of the catalyst layers. The conditions of the air blowing test were follows:
Air pressure applied to electrode: 5 kg/cm²
Distance between electrode and air gun: 5 cm
Electrode area: 1.6 cm×1.6 cm
Angle between electrode and air gun: 90°
Blowing time: 30 sec
Nozzle diameter of air gun: 1.8 mm

After each electrode was weighed before and after the blowing test, the adhesion strength of the catalyst layer was evaluated based on a weight difference before and after the blowing test.

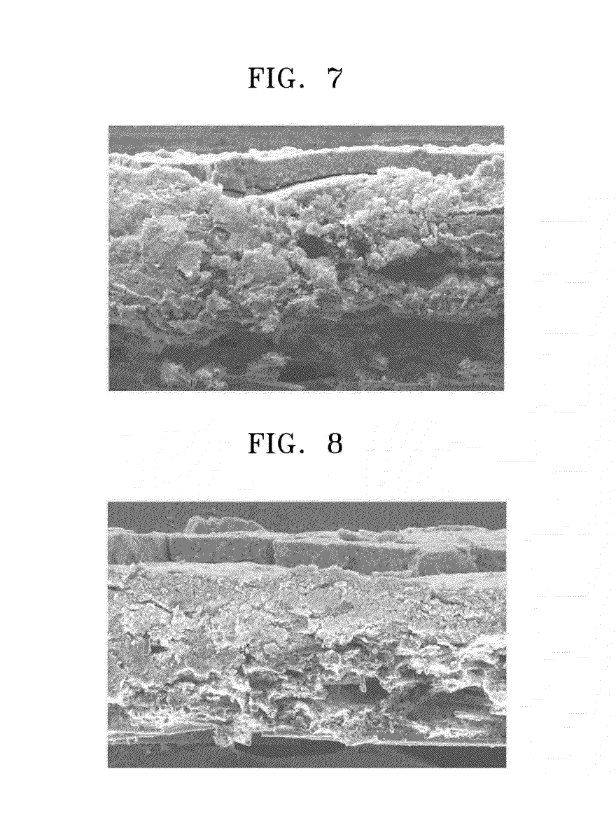

The adhesion strengths of the catalyst layers are shown in FIG. 6.

Referring to FIG. 6, a weight difference of the electrode of Comparative Example 1 is found to be remarkably higher than the weight differences of the electrodes of Examples 1 to 4 before and after the blowing test. This significant reduction in weight difference of the electrode with the catalyst layer before and after the blowing test is attributed to the increased adhesion strength of the catalyst layer to the gas diffusion layer.

### EVALUATION EXAMPLE 2

### Scanning Electron Microscopy (“SEM”) Analysis

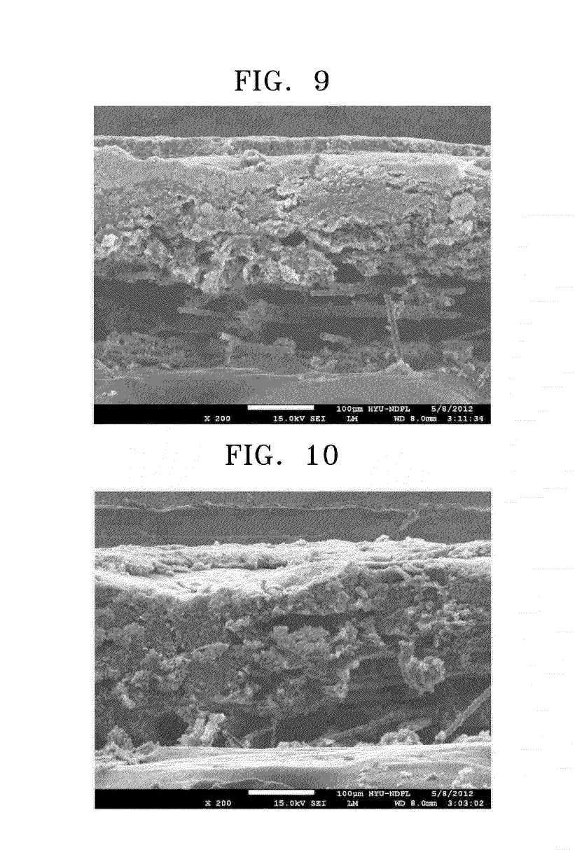

The electrodes of Examples 2 to 4 and Comparative Example 1 were evaluated using scanning electron microscopy (“SEM”). The results are shown in FIGS. 7 to 10.

FIGS. 7 to 9 are SEM images of electrodes of Examples 2 to 4, respectively. FIG. 10 is a SEM image of the electrode of Comparative Example 1.

Referring to FIGS. 7 to 10, the electrodes of Examples 2 to 4 were found to be a more compact structure as compared to the electrode of Comparative Example 1.

### EVALUATION EXAMPLE 3

### Fuel Cell Performance Evaluation

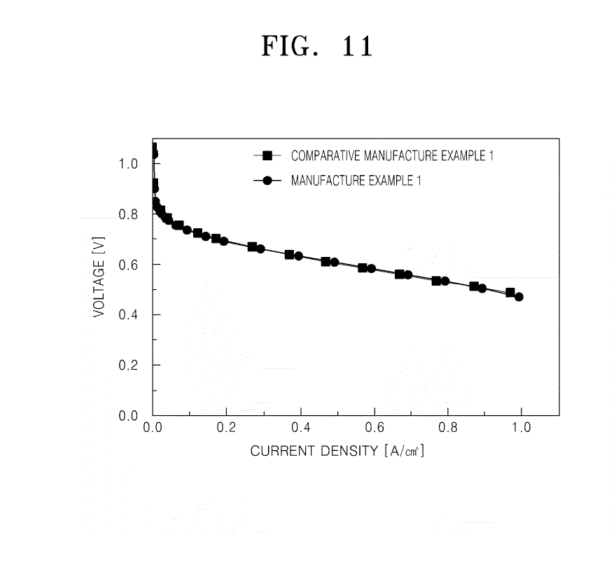

Cell performance of the fuel cells of Manufacture Example 1 and Comparative Manufacture Example 1 were evaluated as follows. The cell performance was tested at about 150° C. using an unhumidified air as a cathode oxidizing agent, and unhumidified hydrogen as an anode fuel. In particular, the operation voltage of each fuel cell was recorded while a stepwise increase in current from about 0 to about 1 Ampere per square centimeter (“A/cm²”). The cell performances of the fuel cells of Manufacture Example 1 and Comparative Manufacture Example 1 are shown in FIG. 11.

Referring to FIG. 11, the fuel cell of Manufacture Example 1 was found to have similar performance to the fuel cell of Comparative Example 1.

As described above, according to the one or more of the above embodiments, due to improved adhesion strength between a catalyst layer and a gas diffusion layer of an electrode for a fuel cell, the electrode may be manufactured using a roll-coating method and may be stored in roll form.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. An electrode for a fuel cell, comprising:
a gas diffusion layer; and
a catalyst layer bound to at least one surface of the gas diffusion layer and comprising a catalyst and a binder.

2. The electrode of claim 1, wherein at least one of the catalyst and the binder comprises an acidic functional group or a basic functional group.

3. The electrode of claim 2, wherein the acidic functional group is at least one selected from a carboxylic acid group, a phosphoric acid group, a sulfonic acid group, and a hydroxy group, and
the basic functional group is at least one selected from an amino group, a pyridine group, a pyridazine group, a pyrimidine group, a pirazine group, a 1,2,3-triazine group, a 1,2,4-triazine group, a 1,3,5-triazine group, an oxazole group, a thiazole group, a 1 H-1,2,3-triazole group, a 1H-1,2,4-triazole group, 2H-1,2,3-triazole group, a 1 H-tetrazole group, a 2H-tetrazole group, and an imidazole group.

4. The electrode of claim 1, wherein
the catalyst comprises a basic functional group, and the binder comprises an acidic functional group;
the catalyst comprises an acidic functional group, and the binder comprises a basic functional group; or
the catalyst and the binder each comprises an acidic functional group.

5. The electrode of claim 1, wherein the gas diffusion layer comprises an acidic functional group, or a basic functional group.

6. The electrode of claim 1, wherein the catalyst layer further comprises a carbonaceous material.

7. The electrode of claim 6, wherein the carbonaceous material is at least one selected from carbon powder, carbon black, acetylene black, ketjen black, activated carbon, carbon nanotubes, carbon nanofibers, carbon nanowires, carbon nanohorns, carbon aerogel, carbon cryogel, and carbon nanorings.

8. The electrode of claim 6, wherein an amount of the carbonaceous material is from about 1 part to about 50 parts by weight based on a total of 100 parts by weight of the catalyst.

9. The electrode of claim 1, wherein the gas diffusion layer comprises a basic functional group; and the catalyst layer comprises:
a catalyst comprising a basic functional group and a binder comprising an acidic functional group;
a catalyst and a binder each comprising an acidic functional group; or
a catalyst comprising a basic functional group, a binder comprising an acidic functional group, and a carbonaceous material.

10. The electrode of claim 1, wherein the catalyst comprises an amino group.

11. The electrode of claim 10, wherein the catalyst further comprises
at least one catalyst metal selected from platinum, iron, cobalt, nickel, ruthenium, rhodium, palladium, osmium, iridium, copper, silver, gold, tin, titanium, chromium, and an alloy of at least two thereof; or
a supported catalyst comprising at least one catalyst metal on a carbonaceous support, the at least one catalyst metal being selected from platinum, iron, cobalt, nickel, ruthenium, rhodium, palladium, osmium, iridium, copper, silver, gold, tin, titanium, chromium, and an alloy of at least two thereof.

12. The electrode of claim 1, wherein
the catalyst layer comprises a binder comprising an acidic functional group, and
the binder comprising the acidic functional group is at least one selected from a poly(olefin) comprising at least one selected from a carboxylic acid group, a sulfonic acid group, and a phosphoric acid group, a halogenated poly(olefin) comprising at least one selected from a carboxylic acid group, a sulfonic acid group, and a phosphoric acid group, a poly(acrylic acid), a poly(methacrylic acid), an isobutylene-maleic acid copolymer), a butadiene-maleic acid copolymer, and a butadiene-maleic acid-olefin terpolymer.

13. The electrode of claim 1, wherein an amount of the binder in the catalyst layer is from about 1 part to about 20 parts by weight based on a total of 100 parts by weight of the catalyst.

14. An electrode catalyst layer for a fuel cell, comprising:
a catalyst comprising an acidic functional group or a basic functional group; and
a binder comprising a basic functional group or an acidic functional group which are effective to form a chemical bond with the acidic functional group or the basic functional group of the catalyst.

15. The electrode of claim 14, wherein
the catalyst comprising a basic functional group,
the binder comprising an acidic functional group, and the binder comprising the acidic functional group is at least one selected from a poly(olefin) comprising at least one selected from a carboxylic acid group, a sulfonic acid group, a phosphoric acid group, a halogenated poly(olefin) comprising at least one selected from a carboxylic acid group, a sulfonic acid group, and a phosphoric acid group, a poly(acrylic acid), poly(methacrylic acid), an isobutylene-maleic acid copolymer, a butadiene-maleic acid copolymer, and a butadiene-maleic acid-olefin terpolymer.

16. An electrode for a fuel cell, comprising:
a gas diffusion layer; and
an electrode catalyst layer disposed on the gas diffusion layer and comprising a catalyst comprising an acidic functional group or a basic functional group, and a binder comprising a basic functional group or an acidic functional group which are effective to form a chemical bond with the acidic functional group or the basic functional group of the catalyst.

17. A fuel cell comprising the electrode of claim 1.

18. A fuel cell of claim 17, wherein at least one of the catalyst and the binder has an acidic functional group or a basic functional group.

19. A fuel cell of claim 17, wherein
the catalyst comprises a basic functional group, and the binder comprises an acidic functional group;
the catalyst comprises an acidic functional group, and the binder comprises a basic functional group; or
the catalyst and the binder each comprise an acidic functional group.

20. A fuel cell of claim 17, wherein the catalyst layer further comprises a carbonaceous material.
